(19) United States
(12) Patent Application Publication
(10) Pub. No.: US 2017/0206664 A1
(43) Pub. Date: Jul. 20, 2017

(54) Method for identifying, tracking persons and objects of interest

(71) Applicant: James Shen, Toronto (CA)

(72) Inventor: James Shen, Toronto (CA)

(21) Appl. No.: 14/995,283

(22) Filed: Jan. 14, 2016

(51) Int. Cl. G06T 7/20; G06K 9/62; G06K 9/20; H04W 4/02

(52) U.S. Cl. CPC G06T 7/20; H04W 4/028; G06K 9/62; G06K 9/209

(57) ABSTRACT

This invention discloses a method for identifying, tracking persons and objects of interest (POI) across multiple monitored areas through means of electromagnetic radiation, sounds and any other sensory inputs in conjunction of location data of electronic devices in the monitored areas.

The methodology includes collecting anthropometric data, metrological measurements and any other data relating to persons and objects of interest and location data of electronic devices in the monitored areas. Applying multiple pattern recognition algorithms and statistical analysis of location data to the persons and objects of interests, the system can deduce and focus on the persons and objects of interest's location, movements across monitor areas of the system.

### FILED OF INVENTION

The present invention relates to identifying and tracking of persons and objects of interests through a monitoring system and integrating with locating data provided by electronic devices or third party location data providers or from any other provider and means of location data.

### BACKGROUND OF INVENTION

The pervasiveness of the security camera monitoring populations and objects have reached unprecedented level. It is estimated in some parts of the world that there is one security camera for every population of ten. However, despite the pervasiveness of camera monitoring, the effectiveness and reliability of camera monitoring is still left much more to be desired for identifying and tracking person of interest.

Identifying and tracking of persons and objects of interest consists of facial recognition and pattern recognition within certain level of confidence. A number of technologies have been introduced to identify person of interests.

Some of the most commonly developed technologies are facial recognition, finger print biometric recognition, object recognitions and etc. Unfortunately, these technologies are not sufficient to perform identification and tracking of persons and objects of interests considering the security systems are often non-operational and/or persons and objects of interests were not known in existing database such as mugshot database, integrated automated fingerprint identification system and etc.

There is a need for an improved system and method for identifying and tracking persons and objects of interest with higher degree of confidence level.

The system and methods introduced in this patent is a pattern recognition based system capturing electromagnetic radiation, sounds and any other sensory outputs of persons and objects of interests, environments and all electronic device's location data in the monitored areas as persons and objects of interests move from one monitored area to others. The system performs pattern recognitions, statistical analysis and maintains a profile database of persons and objects of interests and electronic devices and allows users to set various parameters of identifying, tracking of persons and objects of interests and displays the information through user interfaces.

### BRIEF DESCRIPTIONS OF THE DRAWINGS

The method for identifying and tracking POIs according to the present invention will now be described as the way of examples only, reference is had to the accompanying drawings in which:

FIG. 1 illustrates a physical monitoring system and captured, analyzed data of Persons and Objects of Interests.

FIG. 2 illustrates a flow diagram of systems' data collection, analysis and displays.

FIG. 3 illustrates an embodiment of the data representation from various monitored areas.

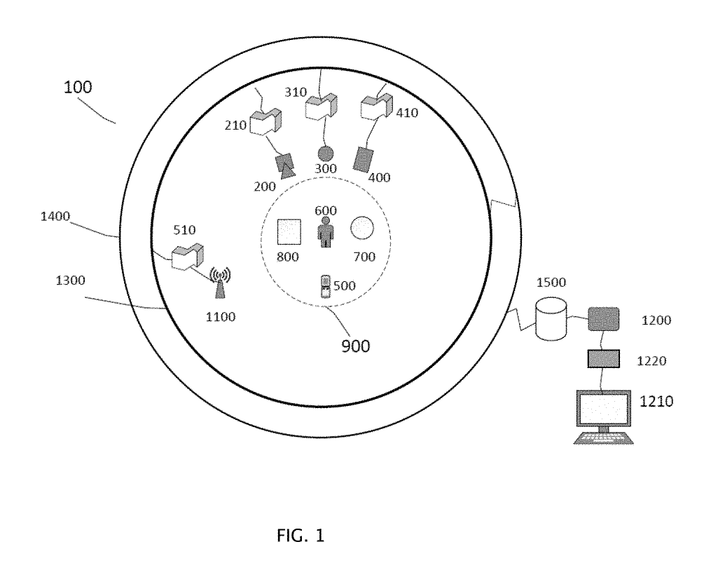

FIG. 1 illustrates a 100 of a physical monitoring system, data flow and processing from Persons and Objects of Interests in monitored area 900. The system 100 comprises at least one electromagnetic radiation detector/camera/stereoscopic camera 200 that is operable in at least one communication network 1300 and/or internet 1400. The system 100 also comprises sound wave detector/microphones 300 that is operable via at least one communication network 1300 and/or internet 1400. The system 100 also comprises any other type of detectors/sensors 400 that sends the measurable signals via communication network 1300 and/or internet. The system 100 comprises at least one electronic device 500 that its device identification, location data 510 can be sent either directly from the electronic device 500 or via a third-party location data provider, i.e. tele communication company, search engine company, via at least one communication network 1300 and/or internet 1400 to the remote center 1200. The system 100 further comprises at least one Person of Interests 600 and Accessories of Interest 700 and Object of Interest 800 that produce electromagnetic radiation signatures, sound wave signatures and/or any other means of signals that can be quantified and analyzed data. The system 100 also comprises a remote center 1200 that is connected to the system 100 via the network 1300 and/or internet 1400 as shown in the FIG. 1. The electromagnetic radiation detector/camera/stereoscopic camera 200 is capable of receiving and storing electromagnetic radiation (EMR) data 210 from person of interest 600, object of interest 800, or any other object of interest 700 and transmitting electromagnetic radiation (EMR) data 210 via the communication network 1300 and/or the internet 1400 to the remote center 1200. The sound wave detector/microphones 300 is capable of detecting and storing sound wave data 310 from and transmitting sound wave data 310 via the communication network 1300 and/or the internet 1400 to the remote center 1200. Any other type of detectors/sensors 400 is capable of detecting, measuring and storing any other type of data 410 from person of interest 600, object of interest 800, another object of interest 700 and transmitting any other type of data 410 via the communication network 1300 and/or the internet 1400 to the remote center 1200. The system 100 also comprises an external database 1500 that may connected to the remote center 1200 directly and/or via the communication network 1300 and/or via internet 1400. The system 100's comprised components such as electromagnetic radiation detectors/camera/stereoscopic cameras 200, sound wave detectors/microphones 300 and any other type of sensors 400, communication devices 500 connected to a receiver 1100 and may also be connected to an external database 1500 via the communication network 1300 and/or internet 1400.

At the beginning, electromagnetic radiation detector/camera/stereoscopic camera 200, sound wave detectors/microphones 300, any other type of detectors/sensors 400, electronic devices 500 simultaneously and continuously receives and/or processes the data 210, 310, 410, 510 from and any persons, objects and the environment from the view of detection/monitoring to the remote center 1200 via the communication network 1300 and/or the internet. The remote center 1200 has processors 1220 and User Interface 1210 allows users to configure, identify, track person of interest 600, object of interest 800, or another object of interest 700.

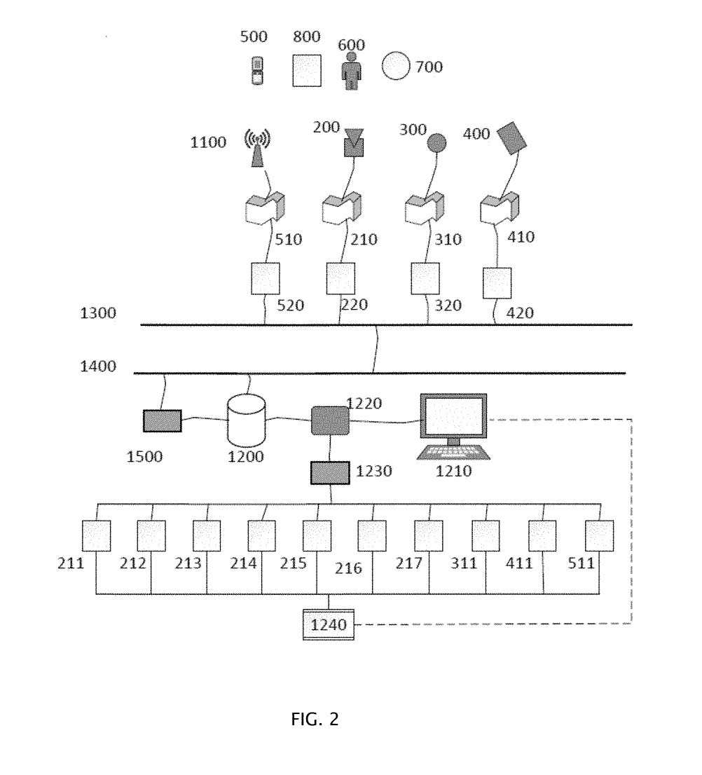

FIG. 2 illustrates an embodiment of the data flow of the invented system. Electromagnetic radiation (EMR) Data 210 is being collected and being organized into a Preliminary EMR Database 220 that can be stored anywhere via the communication network 1300 or the internet 1400 including the remote center 1200. Algorithms 1230 residing in the processors 1220 perform pattern recognitions to electromagnetic radiation (EMR) Data 210 and generate new sets of data such as anthropometric data 211, bio-physiological data 212, posture data 213, gesture data 214, color data 215, dimensional data 216 and any other pattern data 217. Sound wave data 310 is being collected and being organized into a Preliminary Sound Wave Database 320. Algorithms 1230 residing in the processors 1220 perform pattern recognitions to sound wave 310 and generate new sets of data such as sound data 311. Any other type of data 410 is being collected and being organized into a Preliminary Any Other Type of Database 420. Algorithms 1230 residing in the processor 1220 perform pattern recognitions to Any Other Type of Data 410 and generate a new set of data such as AOT data 411. The communication device 500 sends signals to a receiver 1100 with location data 510 which is organized into a preliminary location database 520. Algorithms 1230 residing in the processor 1220 perform pattern recognitions to device identification, location data 510 and generates new set of device identification, location data such as 511. An operator using user interface 1210 that connects to the processor 1220 can identify, remove, and modify data representations of person of interest 600, object of interest 800, another object of interest 700 through any means of the programed method in the processor 1220. The algorithms 1230 in the processor 1220 creates a profile database 1240 on the person of interest 600, object of interest 800, another object of interest 700 that comprises of data such as anthropometric data 211, bio-physiological data 212, posture data 213, gesture data 214, color data 215, dimensional data 216 and any other pattern data 217, sound wave data 311 and device identification, location data 511 and any other type of data 411. The operator using user interface 1210 can program algorithms 1230 residing in the processor 1220 for various pattern recognition functions to perform on profile database 1240 and integrates data with external database 1500. The operator using user interface 1210 programs algorithms 1230 to be self-learning residing in the processor 1220 utilizing data in the profile database 1240.

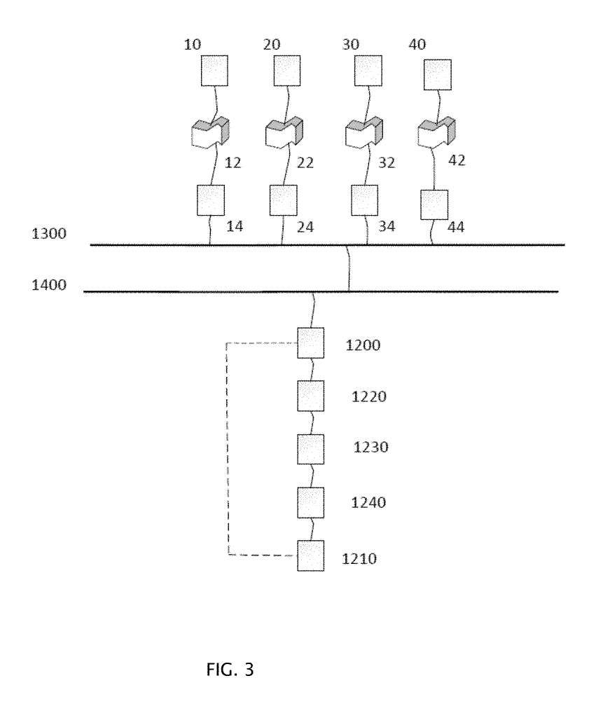

FIG. 3 illustrates an embodiment of the data representation from various monitored areas. Data 12, 22, 32, and 42 is being collected from monitored areas 10, 20, 30 and 40 stored in database 14 any, 24, 34, and 44 connected to communication network 1300 or the internet 1400 including the remote center 1200. Algorithms 1230 residing in the processors 1220 perform pattern recognitions to data 12, 22, 32, and 42.

An operator using User Interface 1210 that connects to the processor 1220 can identify, remove, and modify data representations of monitored areas 10, 20, 30, and 40. The algorithms 1230 in the processor 1220 creates a profile database 1240. The operator using user interface 1210 can program algorithms 1230 residing in the processor 1220 for various pattern recognition functions to perform on profile database 1240 and integrates data with external database 1500. The operator using user interface 1210 programs algorithms 1230 to be self-learning residing in the processor 1220 utilizing data in the profile database 1240.

Therefore what is claimed is:

1. A method for identifying and tracking of persons of interests, accessories of interests and objects of interests across different monitored areas, the method comprising:
Detecting visual, audio and other signals from persons of interests, accessories of interests and objects of interests; Collecting electromagnetic radiation (EMR), sound wave and any other type of data from corresponding detectors; processing said data; storing said data in an external data storage device; and transmitting said data to a remote center via communication network and displaying said data through a user interface.

2. The method of claim 1 wherein said collecting of the data is from visual, sound or any other detectors.

3. The method of claim 1 wherein said visual detectors include cameras in the visible, infrared or other electromagnetic range.

4. The method of claim 1 wherein said audio detectors include microphones.

5. The method of claim 1 wherein said other detection devices include mobile communication devices.

6. The method of claim 1 wherein said processing of said visual data includes performing pattern recognition on the collected electromagnetic radiation data and generate new sets of data such as anthropometric data, bio-physiological data, posture data, gesture data, color data, dimensional data and any other pattern data and transmits said data to the remote center.

7. The method of claim 1 wherein said processing of said sound detectors performs pattern recognition on the collected sound data and generates new sets of data such as sound recognition, speech recognition data and transmits such data to the remote center.

8. The method of claim 1 wherein said data from any other type of detectors performs pattern recognition on said data and transmits said data to the remote center.

9. The method of claim 1 wherein storing said data include external storage mediums including memory storage devices, processors, and related algorithms.

10. The method of claim 10 wherein algorithms residing in said processor performs pattern recognitions on data transmitted from said devices such as electromagnetic detectors/cameras/stereoscopic cameras, sound wave detectors/microphones, any other type of sensors/detectors, electronic devices.

11. The method of claim 11 wherein said algorithms provide predicative location of persons of interests, accessories of interests, objects of interest and displays said information on the user interface.

12. The method of claim 11 wherein data generated from said algorithms are used to create a profile database that comprises attributes comprise anthropometric, bio-physiological, posture, color, dimensional, electronic devices and etc.

13. The method of claim 12 wherein the said profile data are used for programming said self-learning algorithms for pattern recognitions of persons, accessories, objects of interests.

14. The method of claim 11 wherein said algorithms perform statistical analysis on said database and determined what profile data are required for identification and tracking of persons, accessories and objects of interests.

15. The method of claim 11 wherein said algorithms are self-learning through user interface utilizing data collected from said devices such as electromagnetic radiation detectors/cameras/stereoscopic cameras, sound wave detectors/microphones, any other type of detectors/sensors, electronic devices and external database.
